(19) United States
(12) Patent Application Publication
(10) Pub. No.: US 2008/0046949 A1
(43) Pub. Date: Feb. 21, 2008

(54) Spectrum sharing between broadcasting and multiple-access networks

(75) Inventor: Hui Liu, Sammamish, WA (US)

Correspondence Address: FULBRIGHT & JAWORSKI L.L.P, 2200 ROSS AVENUE, SUITE 2800, DALLAS, TX, 75201-2784, US

(73) Assignee: Adaptix, Inc., Seattle, WA (US)

(21) Appl. No.: 11/492,709

(22) Filed: Jul. 25, 2006

(51) Int. Cl. H04N 7/173; H04N 7/20

(52) U.S. Cl. 725/118; 725/120; 725/73

(57) ABSTRACT

Advantage is taken of the fact that broadcast coverage is unevenly distributed across a geographical region and multiple-access transmissions can be interposed in regions where interference is minimum. In one embodiment, advantage is taken of the known broadcasting signal and techniques, such as, for example, dirty paper coding techniques, can be used to pre-cancel broadcasting differences, allowing a system to operate as if the interference did not exist.

### TECHNICAL FIELD

This invention relates to the use of frequency spectrum and more particularly to systems and methods for sharing spectrum between broadcast and multiple-access networks.

### BACKGROUND OF THE INVENTION

Frequency spectrum for wireless applications, such as, for example, wireless communications, is a limited resource. Traditionally, in the public sector the primary use of spectrum has been for broadcasting AM and FM radio as well as for broadcasting television. In this context broadcasting is the transmission of an air interface signal from a transmission point to a plurality of receivers. Broadcast transmissions traditionally have been uni-directional in nature.

The public has also been using another portion of the frequency spectrum for bi-directional wireless communications. Typically, the bi-directional spectrum has been used for cellular communication. These networks can be thought of as multiple-access networks since they serve multiple users simultaneously but separately. The popularity of bi-directional (multiple-access) communication, especially for data communication, has led to the deployment of numerous additional networks, such as, for example, Wi-Fi. The continuing demand for additional wireless capacity has put strain on frequency spectrum utilization and is causing tension between broadcast-only spectrum and bi-directional spectrum.

Further compounding the problem is the fact that on a going forward basis it may be that broadcast transmissions will also utilize bi-directional communications which will further exacerbate the tensions between broadcast and multiple-access networks which are designed to be isolated from each other such that at the infrastructure levels, the transmission schemes and the equipment used to achieve communications are different.

### BRIEF SUMMARY OF THE INVENTION

Advantage is taken of the fact that broadcast coverage is unevenly distributed across a geographical region and multiple-access transmissions can be interposed in regions where interference is minimum. In one embodiment, advantage is taken of the known broadcasting signal and techniques, such as, for example, dirty paper coding techniques, can be used to pre-cancel broadcasting differences, allowing a system to operate as if the interference did not exist.

In one embodiment, the transmission capabilities of both broadcasting and multiple-access can be combined so that both transmissions can occur using a unified or coordinated network. In some situations it would even be possible to combine the spectrum for joint use by both types of transmission.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawing, in which:

FIG. 1 illustrates one embodiment of the invention having a combined broadcasting and multiple-access system;

FIG. 2 is a block diagram illustrating one embodiment of an interference cancellation scheme for use in situations where both broadcast and multiple-access transmissions overlap in a geographical area;

FIGS. 3A and 3B illustrate one embodiment of a frame structure for achieving pre-cancellation;

FIG. 4 illustrates one embodiment of the overlay between broadcasting and cellular transmission; and

FIG. 5 shows one embodiment of a pre-cancellation modem structure.

### DETAILED DESCRIPTION OF THE INVENTION

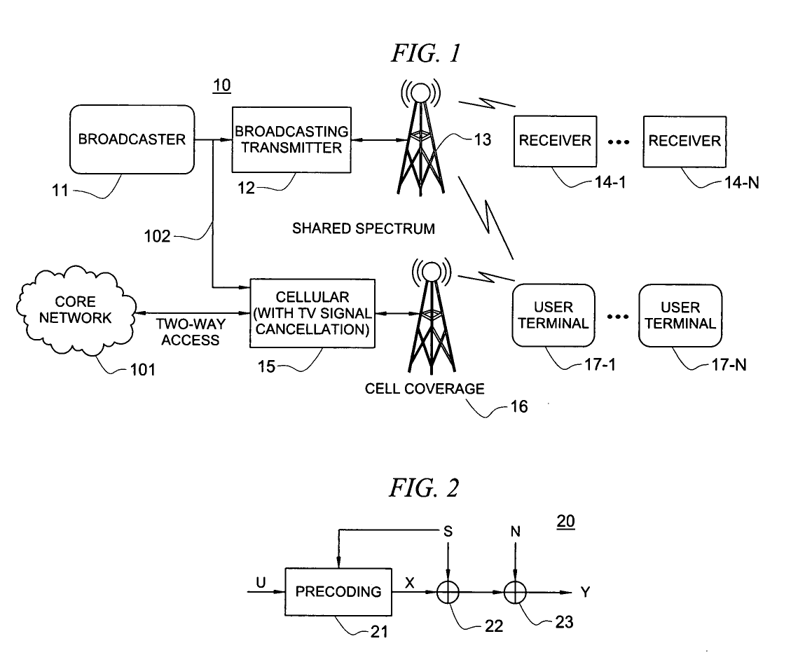

FIG. 1 illustrates one embodiment of the invention having broadcasting (elements 11, 12 and 13) and multiple-access (elements 15 and 16) combined into a single network 10. In the traditional system, broadcaster 11 would send signals to broadcasting transmitter 12 which in turn would provide those signals (along with the proper power) to a broadcasting antenna high above the ground, such as on tower 13. In such systems, the transmission power is high and can be as much as 10,000 watts, yielding a large (typically ten or more miles) geographical coverage area, such that broadcast reception is available at receivers 14-1 to 14-N spaced apart around the area.

The traditional cellular network, or a WiMAX type of 3G system, is depicted in FIG. 1 by core network 101 having a plurality of transmitters, such as transmitter 16, controlled by individual base stations. In such systems, the transmission is between the base station and selected individual user terminals, such as terminals 17-1 to 17-N, and is relatively low power. These terminals could be, for example, cellular telephones, or PCs, PDAs or the like. Each communication between a basestation and a mobile user is on a separate communication path, which could be separate frequencies, portions of frequencies, time slices of the same frequency, etc.

If nothing else were to be done, communications from the two towers 13 and 16 would interfere with each other if they were to use the same frequency spectrum. However, by feeding the signals (or at least a portion of the signals) from broadcaster 11 to base station 15, for example via communication path 102 (which can be wireline or wireless), it is possible to share the spectrum while reducing or eliminating interference there between.

Connection 102 can be a fiber connection or a microwave connection or any other transmission medium. In some situations it might be desirable to communicate the desired data from tower 13 to tower 16 with the goal of making the wave forms from the broadcast system available to the multiple-access system. In this manner the analog broadcast signals can be recreated at the multiple-access system. Using this knowledge, cancellation schemes such as dirty paper coding (DPC) can be used. DPC is discussed in a paper titled Writing On Dirty Paper by Max Costa, IEEE Transaction on Information Theory, Vol IT-29, no 3, May 1983, which paper is hereby incorporated by reference herein.

FIG. 2 is a block diagram illustrating one embodiment of an interference cancellation scheme for use in situations where both broadcast and multiple-access transmissions overlap in a geographical area. In FIG. 2, u represents the source message from a cellular base station; y is the received signal at the user; x is the transmit signal from the cellular (which in the embodiment shown has been groomed by grooming circuitry 21 to remove interference based on broadcast signal s) and s is the broadcasting interference; n is the noise. The signal y delivered to the user is affected by the noise, which can be determined and thus accounted for in the normal manner. The received signal is then given by the equation y=x+αs+n where α is a complex scalar due to wireless channel gain. If the channel gain a is available at the transmitter, DPC can be realized. Circles 22 and 23 represent the fact that the noise and the broadcast signal have been added, but are not actual summing devices.

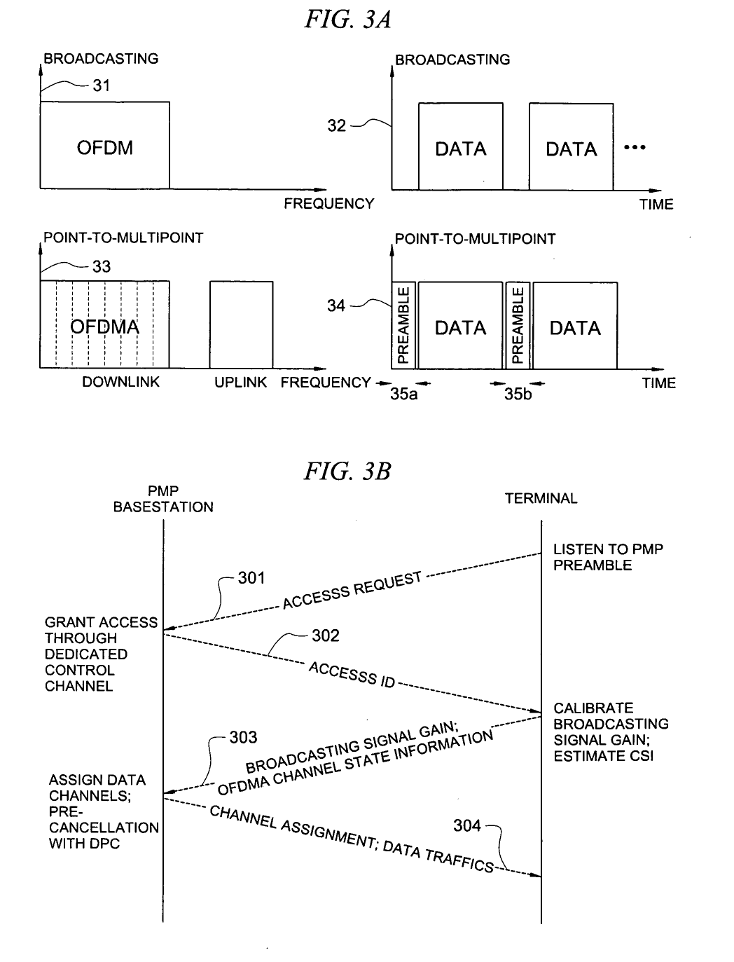

The above discussion is a simplified model having no phase ambiguity. In actuality, the s and x may have a relative phase difference, which must be accounted for. FIGS. 3A and 3B incorporate phase as well as amplitude cancellation.

In order to reduce the broadcasting interference to the simplified model described in FIG. 2, a proper modem structure and signaling protocol must be established. One embodiment of such a structure involves orthogonal frequency division multiplexing (OFDM) based broadcasting and orthogonal frequency division multiple access (OFDMA) cellular that allows multiple users to share the frequency band dynamically so as to optimize the net instantaneous transmission rate.

FIGS. 3A and 3B illustrate one embodiment of a frame structure for achieving pre-cancellation. In particular, as shown in FIG. 3A, the network is shown using the OFDM modulation scheme, shown as 31, so that frequency selective fading channels are converted into parallel frequency non-selective (scalar fading) subchannels. Within the same spectrum, multiple-access from the cellular basestation is accommodated in an OFDMA fashion, shown as 33. Under this configuration, the input/output relation within each OFDM(A) subchannel is that of FIG. 2. As long as the scalar channel gain associated with the broadcasting signal can be fed back to the basestation, interference-free communication can be achieved through DPC.

It is difficult in the time period before access is achieved by a mobile station to do pre-cancellation (grooming). This is so because prior to an actual communication connection it may be difficult to perform any necessary calibration between the mobile station and the base station. Thus, in the embodiment shown, there are preamble periods 35 in time domain multiple-access 34 which match silent periods 36 in broadcasting time domain 32. These preamble periods allow the multiple-access system to send out preamble signals that are not modified (groomed) from the cellular base station so that mobile users can access the network. Preamble periods 35 allow users to calibrate, synchronize and to establish user IDs, etc. Preamble signals can use a frequency spectrum, or a modulation scheme that is not effected by the frequency overlap with the broadcast signals. After the link is established, the data portion of the multiple-access signals and the broadcasting signals overlap, and thus the interference must be eliminated in the manner discussed herein.

In this particular example, uplink from user terminal to the cellular basestation is accomplished in a different frequency bank, as in a typical frequency division duplexing (FDD) system. Time division duplexing (TDD) can be employed to achieve the same goal.

In an alternative embodiment, long spread-spectrum signals are used as cellular preambles in the presence of broadcasting data. Once the initial acquisition is complete, regular data links between the basestation and the terminal can be maintained via DPC with channel gain feedback. The information exchange between the basestation and the terminal is similar to that of downlink beamforming, except in this case the protocol overhead is merely a scalar.

In one embodiment, a media access control (MAC) protocol, such as the one highlighted in FIG. 3B, is employed. Appropriate signals and channel estimation and feedback mechanisms are among other important functions of the MAC protocol. Arrow 301 from the terminal to the base station is an access request. Then the base station grants the request as shown by arrow 302 and tells the mobile station the dedicated channel, and also provides the user ID. Arrows 303 and 304 deal with negotiations for calibration and other housekeeping chores in order to establish a proper communication connection.

The system then knows that a particular user is operating on a particular sub-channel and that there is now a need to estimate calibration parameters required for that channel. Once the system knows the parameters, it may perform pre-cancellation as discussed above.

Alternatively, the interfering signal can be post-subtracted from the received signal at the user terminal. In particular, the broadcasting signal s is mixed with the user signal u at the cellular basestation. At the user terminal, the receiver simply estimates the channel gain α, and then subtracts the interfering signal as to arrive at the interference free signal y.

The prior art in broadcasting and cellular assumes insulated infrastructures. The macro-coverage broadcasting tower has a much broader footprint than a cellular cell, but the spectra allocated for the two networks are spaced apart (with a typical guard bank of 40 MHz or more) to avoid interference.

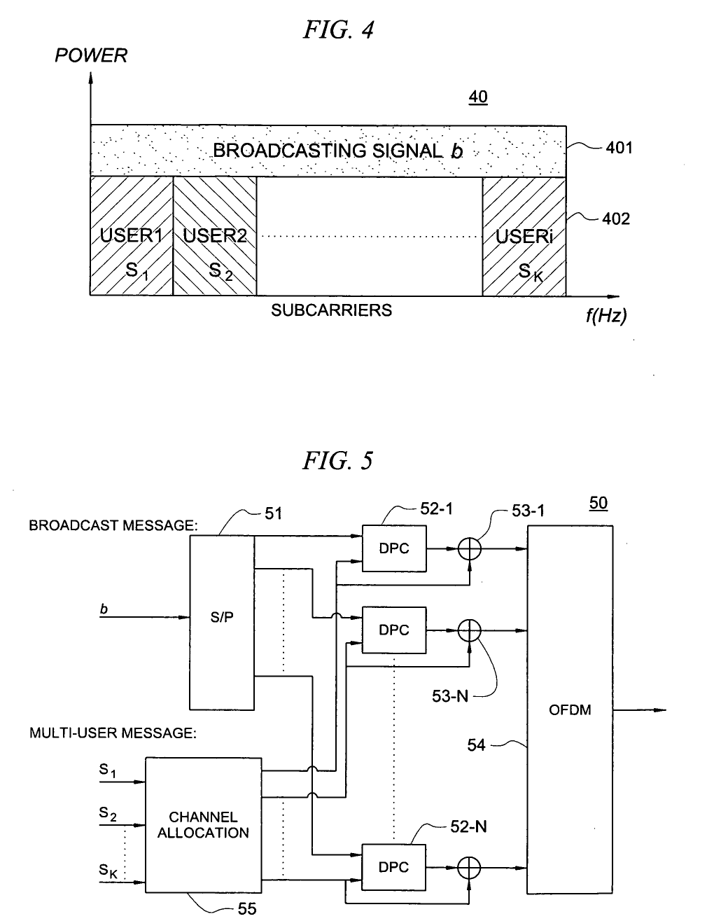

FIG. 4 illustrates one embodiment 40 of the overlay between broadcasting and cellular transmission. In embodiment 40, the high-power broadcasting tower (and its dedicated spectrum) is eliminated. Broadcasting service is accommodated by overlaying it on top of a cellular network, using the same cellular spectrum. Specifically, the cellular base station (BTS) transmits both one-to-one signals (s_{—}{1,} . . . , s_{K}) (area 402) with each user occupying a different portion of the spectrum. The broadcasting signal b (area 401) is transmitted in such a way that any user within the coverage area can receive b without experiencing interference from one-to-one signals (s_{—}{1, } . . . , s_{K}). The broadcast signal can be overlaid in one set of bands or, if desired, on multiple sets of bands. The totality of the overlaid broadcast signal constitutes an overall broadcast spectrum. Since the multiple-access/one-to-one signal is pre-cancelled out, the television receiver will be able to decode the television signal as if the one-to-one signal does not exist.

The key here is that the broadcast signal is spread out so that interference with cellular operation is minimal. The TV signal is much weaker at each frequency but by using a pre-cancellation mechanism the cellular interference through that portion of the broadcast signal is eliminated. FIG. 5 illustrates one embodiment for accomplishing this desired result.

FIG. 5 shows one embodiment 50 of a pre-cancellation modem structure. This embodiment illustrates the basic principles of the overlay network where the modulation structure at the transmitter is depicted. This embodiment uses an OFDMA cellular network, such as 802.16e WiMAX, although the invention can be easily applied to other cellular systems using different multiple access schemes, such as, for example, TDMA, CDMA, and multicarrier multiple-access.

In embodiment 50 each sub-carrier, S₁, S₂ to Sₖ is assigned to a unique user or a set of users using space-division multiple access ( SDMA) according to the users' channel. SDMA channel allocation strategy may be based on the users' channel profiles and controlled, for example, by channel allocation 55. Within the same spectrum, the broadcasting signal is transmitted over multiple subcarriers and via serial to parallel (S/P) converter 51 is placed on top of the one-to-one communication signals. To avoid interference from the one-to-one signal, say, s₋{k}, to the broadcasting signal, dirty paper coding (DPC) is performed in each subcarrier to pre-cancel out the interference by DPC correction 52-1 to 52-N. The result of the signal grooming is combined via 53-1 to 53-N prior to being transmitted via OFDM system 54.

To be specific, in each subcarrier the one-to-one signal is regarded as interference to the broadcasting signal. Using DPC, such an interference is pre-cancelled at the BTS. As a result, a broadcasting receiver (e.g., the TV set) can decode the broadcasting signal as if no one-to-one interference exists.

On the other hand, from the stand of point view of the cellular users (to whom (s_{—}{1, } . . . , s_{K} intent), the broadcasting signal does constitute a small interference. However, as shown in FIG. 4, the broadcasting signal is delivered across a much wider frequency band (or even across multiple cellular bands). Therefore its power spectrum (power per subcarrier) can be much lower than that of the one-to-one signals. Such an arrangement makes it possible to achieve spectrum-free broadcasting while allowing multi-user system (cellular) to work property.

In another embodiment, broadcasting can be overlaid on top of multiple cellular bands. This increases the broadcasting bandwidth, allowing for higher broadcast data rates.

A number of DPC implementation algorithms can be employed, including the trellis code approach discussed by W Yu, D. P. Varodayan and J. M Cioffi, “Trellis and convolutional preceding for transmitter-based interference presubstraction,” IEEE Trans. on Communications, vol. 53, no. 7, pp 1220-1230, July 2005, which paper is hereby incorporated by reference herein, and the structural DPC (SDPC) method shown. The SDPC is computational advantageous due to the exploitation of the structure information embedded in the interfering signal.

Another alternative implementation is to pre-cancel the broadcasting signal from the one-to-one signal using DPC. In this case, the one-to-one signal will experience zero interference from the broadcasting signal. On the other hand, the broadcasting signal will suffer from some inherent interference from the one-to-one signals.

Note that all interference need not be removed in many situations. Rather, reducing interference to an acceptable level may allow a required reception quality. Voice communication acceptability is usually lower than it would be for data transmission. One definition of acceptability could be a bit error rate less than 1%.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A wireless system comprising:
a broadcast transmission operating within a certain frequency spectrum, said broadcast transmission operating at relatively high power;
a multiple-access transmission operating within said same certain frequency spectrum, each said multiple-access transmission at a significantly lower power level than said broadcast transmission; and
interference apparatus for canceling interference between said broadcast and multiple-access transmissions as seen by the respective receivers of both said broadcast and multiple-access transmissions.

2. The system of claim 1 wherein said interference apparatus uses, at least in part, dirty paper coding techniques.

3. The system of claim 1 wherein said transmission is TV transmission within a frequency spectrum assigned for publicly available TV.

4. The system of claim 3 wherein said multiple access transmission is OFDMA.

5. The system of claim 4 wherein the broadcast power spectrum is spread over a number of multiple-access user channels.

6. The system of claim 1 wherein said interference apparatus is operative for allowing for the initial establishment of a multiple-access user transmission without said cancellation.

7. A wireless communication system comprising:
a modulation scheme for controlling multiple access transmission from a base station to specific ones of mobile user terminals; and
signal grooming circuitry for allowing said multiple access transmission to be acceptably received by said users even when broadcast signals are present in the same frequency spectrum as said transmission, acceptability being defined as a bit error rate less than a predefined threshold.

8. The system of claim 7 wherein said defined threshold is 1% or less.

9. The system of claim 7 wherein said grooming circuitry uses, at least in part, dirty paper coding techniques.

10. The system of claim 7 wherein said multiple access transmission is OFDMA.

11. The system of claim 7 wherein the broadcast power spectrum is spread over a number of multiple-access user channels.

12. The system of claim 7 wherein said grooming circuitry is operative for allowing for the initial establishment of a multiple-access user transmission without said cancellation.

13. A method of operating a broadcast transmission system in a frequency spectrum that overlaps the frequency spectrum of a multiple-access, said method comprising:
grooming said broadcast transmissions to remove interference from said multiple-access transmissions; and
grooming said multiple-access transmissions to remove interference from said broadcast transmissions.

14. The method of claim 13 wherein each said grooming takes into account the modulation techniques of the other transmission system.

15. A method for operating a wireless system, said method comprising:
broadcasting RF transmissions at relatively high power within a certain frequency spectrum;
broadcasting multiple-access RF transmissions within said same certain frequency spectrum, each said multiple-access RF transmissions broadcast at a significantly lower power level than said broadcast transmissions; and
canceling interference between said broadcasted RF transmissions and said broadcasted multiple-access transmissions, said cancellations as seen by the respective receivers of both said broadcast and multiple-access RF transmissions.

16. The method of claim 15 wherein said interference apparatus uses, at least in part, dirty paper coding techniques.

17. The method of claim 15 wherein said multiple access RF transmissions are in the OFDMA format.

18. The method of claim 17 wherein the broadcast power spectrum is spread over a number of multiple-access user channels.

19. The method of claim 15 wherein said cancellation comprises:
allowing for the initial establishment of a multiple-access RF transmission without said cancellation.

20. The method of claim 15 wherein said RF transmission is a TV transmission within a frequency spectrum assigned for publicly available TV.
